(19) United States
(12) Patent Application Publication
(10) Pub. No.: US 2007/0156460 A1
(43) Pub. Date: Jul. 5, 2007

(54) System having a locally interacting distributed joint equilibrium-based search for policies and global policy selection

(76) Inventors: Ranjit R. Nair, Minneapolis, MN (US); Milind Shashikant Tambe, Rancho Palos Verdes, CA (US); Pradeep Reddy Varakantham, Los Angeles, CA (US); Makoto Yokoo, Sawaraku (JP)

Correspondence Address: HONEYWELL INTERNATIONAL INC., 101 COLUMBIA ROAD, P O BOX 2245, MORRISTOWN, NJ, 07962-2245, US

(21) Appl. No.: 11/321,339

(22) Filed: Dec. 29, 2005

(51) Int. Cl. G06Q 40/00

(52) U.S. Cl. 705/4

(57) ABSTRACT

A system for coming up with policies of behavior for various agents engaged in a task. These policies consider costs and benefits of actions and outcomes, and uncertainties. The system utilizes limited neighborhoods of agents for expedited computing in large arrangements. Also sought are local and global optimums in terms of selecting policies.

### BACKGROUND

The invention relates to computing policies for multiple agents, particularly those engaged in tasks together. More particularly, the invention pertains to agents whose interactions are loosely coupled.

### SUMMARY

The invention involves algorithms for coming up with policies of behavior for various agents engaged in a task. These policies consider costs and benefits of actions and outcomes, and uncertainties.

### BRIEF DESCRIPTION OF THE DRAWING

FIGS. 1a and 1b are diagrams of nodes and interconnecting lines to illustrate exploitation of a locality of interaction among nodes, agents, vertices, or the like;

FIG. 1c is a table of variables, their domains and related values;

FIG. 2 is a graph of local optima of policies or plans of agents;

FIG. 3 shows an example domain with targets having various locations and agent sensors for tracking the targets;

FIG. 4 is a diagram representing the interactions among the sensing agents in terms of rewards for tracking and the individual agent's costs for scanning;

FIGS. 5 and 6 are flow diagrams of approaches for achieving a local optimum;

FIG. 7 is a tree diagram of the example domain shown in FIG. 3 and interaction graph in FIG. 4 for computing values and policies;

FIG. 8 is a flow diagram of an illustrative example for achieving a global optimum;

FIGS. 9, 10 and 11 show run time graphs for comparing a present algorithm with other algorithms;

FIG. 12 is a value graph of the present algorithm for various numbers of runs for the three and four agent chain configurations; and

FIG. 13 is a table comparing a present algorithm with other algorithms in terms of numbers of cycles for convergence, number of calls to compute the local policy, and number of policy changes per cycle.

### DESCRIPTION

The present invention pertains to distributed partially observable Markov decision problems (DPOMDPs). The invention involves algorithms for distributed POMDPs that exploit interaction structure. The invention links performance to the optimality of decision making. The invention may also relate to distributed decision making and reasoning under uncertainty. One may solve networked DPOMDPs using DCOP (distributed constraint optimization problem) techniques. The invention may be used in supply chain planning tools that consider uncertainty and logistics planners.

The present invention is intended to take into account the network structure of the interaction of multiagent teams in order to compute policies of behavior that take into account the costs and benefits of actions and outcomes and the uncertainty in the domain.

The invention may identify the kind of interactions between multiple agents that are engaged in a cooperative task. It then may construct an interaction graph that mathematically captures this interaction. This interaction is utilized by two algorithms that can be used to come up with policies of behavior for the different agents: 1) A locally optimal algorithm; and 2) A globally optimal algorithm. The locally optimal algorithm is a distributed algorithm where the agents compute their local policies in a distributed manner communicating only with those agents that are connected to it in the interaction graph. The globally optimal algorithm is a hierarchical algorithm that first converts the interaction graph into a tree and then uses this tree structure to compute joint policies for the team of agents.

The first step in using this invention is to build factored POMDPs of the domain. This involves specifying the local states for each agent, the unaffectable state of the world, the local state transition probabilities, the unaffectable state transition probabilities, the local and unaffectable observation functions, and the local reward functions. Next, one may construct the interaction graph based on the local reward, observation and transition functions. Then, one may decide whether to apply the locally optimal algorithm or the globally optimal algorithm. Usage of each of these algorithms may be presented here.

A DPOMDP may relate to reasoning about the uncertainty in a domain owing from non-determinism and partial observability. Agents may optimize social welfare (team reward). The present approach may explicitly reason about (±) rewards and uncertainty about success or what is occurring. Related art approaches may use centralized planning and distributed execution. With related-art approaches, the complexity of finding an optimal policy may be very high. (“Policy” means “plan” in the present artificial intelligence context.)

In many domains, not all agents can interact or affect each other. Related-art DPOMDP algorithms generally do not exploit locality of interaction. Domains may include distributed sensors, disaster rescue areas and battlefields. The agents in these domains may be sensors, firefighters and ambulances, helicopters and tanks, or other entities.

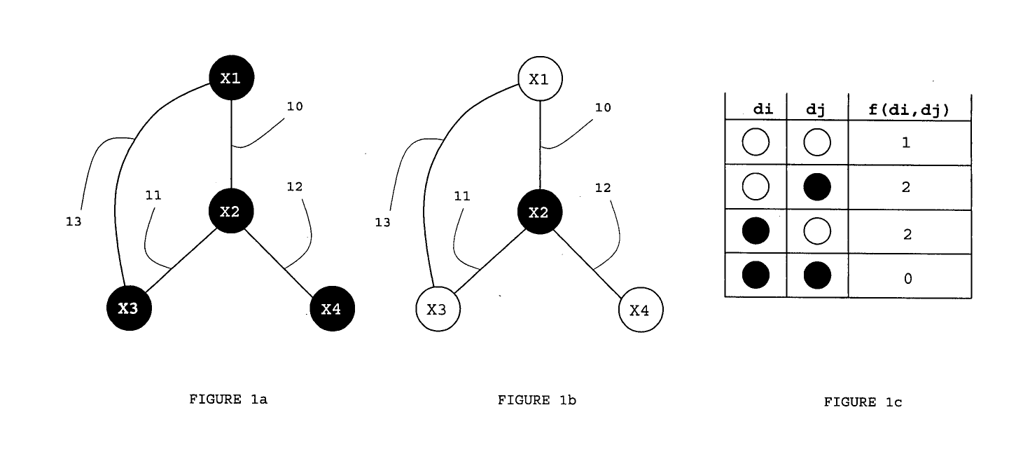

A background of a distributed constraint optimization problem (DCOP) may involve FIGS. 1a and 1b of vertices versus edges. The vertices are an agent's variables (x1, x2, x3 and x4) each with a domain d1, . . . , d4, respectively. The edges 10, 11, 12 and 13 represent rewards. DCOP algorithms exploit locality of interaction. DCOP algorithms do not reason about uncertainty.

In a table of FIG. 1c, di is a domain of variable i, and dj is a domain of variable j. Each of the variables has its own domain—values that it can take. The circles in FIGS. 1a and 1b are nodes. The lines 10, 11, 12 and 13 are edges. An edge may represent the function of two associated nodes, f(di,dj), where di is the domain (white or dark) of one node (i.e., x1, x2, x3 or x4) and dj is the domain of another node. So looking at the table of FIG. 1a, any two nodes or vertices of each edge are dark and the value for the respective edges is zero, resulting in a total value or cost of zero. In FIG. 1b, three edges 10, 11 and 12 connect a dark node and a white node for a value of 2 for each edge. The other edge 13 connects two white nodes for a value of 1. The sum of the values for the four edges is 7. The value or cost of the arrangement in FIG. 1b is 7.

The key idea includes exploiting the locality of interaction in order to solve large scale multi-agent decision problems under uncertainty. In the present approach, each agent only considers its own neighborhood of agents when computing its policy. Other approaches, which don't consider neighborhoods, may scale poorly as the problem scales up and the number of agents increase. In the present approach, all of the agents do not interact. It has algorithms that apply in certain application domains. With not all of the agents interacting, the algorithm can operate faster. Thus, by considering neighborhoods, it can practically solve larger problems. It can come up with plans faster.

The present technique has a hybrid DCOP-DPOMDP approach to collaboratively find a joint policy (i.e., plan). Related-art algorithms are central planners. The present approach allows each agent to have its local policy (own plan). A distributed algorithm involves an integration of agents' local policies or plans. There is a “joint search for the policies.” The local plans together form a joint plan.

A network distributed (ND) POMDP model may capture the locality of interaction. A local optimum may be found with a locally interacting distributed joint equilibrium-based search for policies (LID-JESP). There may be one local policy or plan per agent.

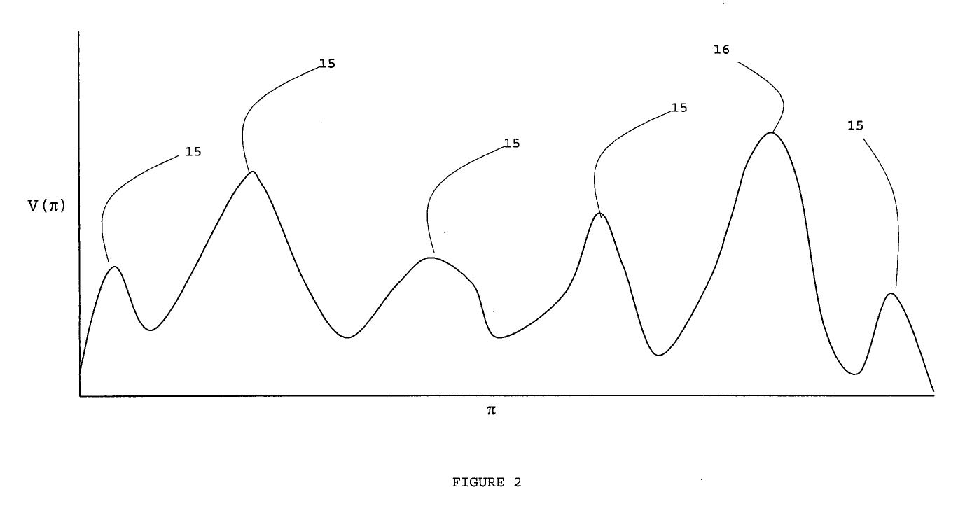

FIG. 2 shows various local optima 15 in terms of vertices V(π) versus π. The π in the figure refers to the joint policy. The curves in the figure may be referred to “hills” of which higher up the curve, a more optimum value of the policy or plan is attained. When agents make changes to the local plan or policy, the value of the policy gets higher up the “hill”, collectively. If another agent changes a local plan, the value gets to a higher point up on the curve. Agent's changes of a local plan or policy may continue until a local optimum 15 is reached. The local algorithm could find the global optimum 16 since a global optimum is the highest of local optima.

Another algorithm may be resorted to for attaining a global optimum value 16. This algorithm may be referred to as a globally optimal algorithm (GOA). Variable elimination has application to solving presently applicable problems. There may be a sensor net domain. The ND-POMDPs may serve as a mathematical model and the LID-JESP may serve as worthy for finding optimum values. Implementation of the algorithms may be realized with experiments.

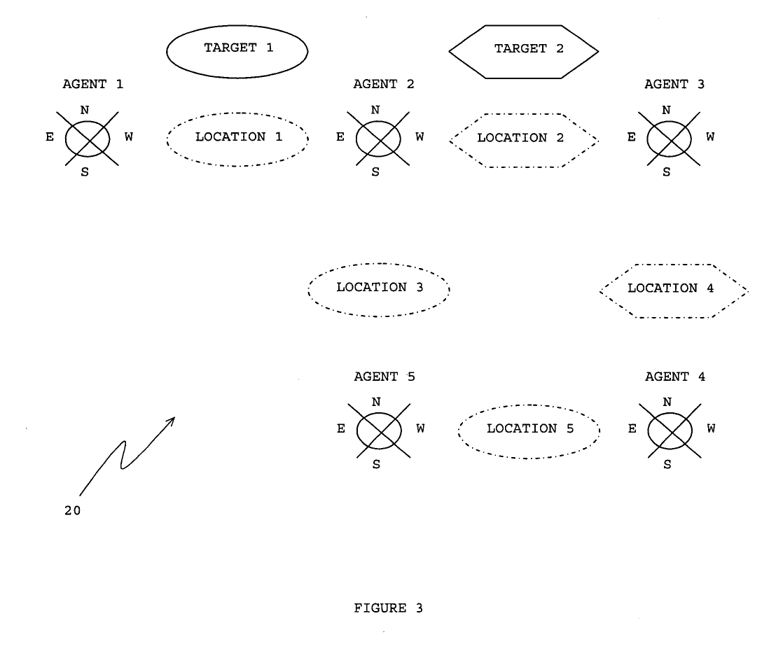

FIG. 3 shows an example domain 20. There may be 5 agents 1 through 5 and two independent targets 1 and 2. Each agent has a sensor. Target 1 may be situated in a location 1, 3 or 5. Target 2 may be situated in a location 2 or 4. Or target 1 may be absent from the location 1, 3 or 5 or all locations, and target 2 may be absent from the location 2 or 4 or both. An absence would be where the target is outside of the tracking area. Each target may change position or location based on its stochastic transition function. Stochastic means that the outcome may be uncertain to some extent, in that there is some probability associated with the target and its location. Each agent is tied in with a sensor for observing a target at a certain location or position. Such location may even be referred to as a sector. There is a transition function that indicates a probability that a target is going to be in the next step or location. The sensor may have four sectors for observation in a particular direction, N, E, W or S, when looking to observe a target at a certain location. The sensor may be referred to as a node, an agent, or the like having the four sectors (directions) of observation. Only one sector may be enabled at one time for observing a target. Further, the sensor needs to have the respective sector of the sensor facing the location of a prospective target in order to locate the target.

There needs to be two sensors, each having a sector facing the same place, to get the location of a target. Each target may have a value of importance that is different from that of another target. One target may be picked over another target because of the former having a greater importance as one factor. Another factor may be the probability of the target's presence at the location under observation. These factors are significant for a target selection which may be expressed as a product of importance and probability.

Sensing agents cannot affect one another or a target's position, since the agents may just observe or sense. In observing targets, there may be false positives and false negatives. A false positive may be where the agent says that a target is in a certain location but it really is not. A false negative is where the agent says that the target is not in the certain location but it really is at that location. A cause of a false positive or false negative may be noisy sensor information.

A reward may be obtained if two agents together track a target correctly. There may be a cost for just leaving a sensor on.

There may be a ND-POMDP for a set of n agents (Ag): <S,A,P,Q,Ω,R,b>, where S is a world state which may include the state of each agent. The world state sεS where
S=S₁× . . . ×Sₙ×Sᵤ.
S₁ is the state of the first agent. Sₙ is the state of the n^{th} agent (i.e., agent n). The present instance of agents and targets in FIG. 3 has five agents, so n may be equal to five. Relative to each agent i (i.e., “i” may designate one of the first through fifth agents), iεAg may have a local state sᵢεSᵢ. “sᵢ” may be the local state of agent i. “Sᵢ” indicates a set of states of which sᵢ is a member. The local state of an agent may be “on” or “off”, which is a status of the agent. The status may involve asking a question whether the sensor is on or off.

“Sᵢ” may include all possible local states. “Sᵤ” may indicate that the locations of the targets (2 targets in the present instance of FIG. 3) are of an unaffectable state of the world. No agent can influence the targets but only observe the targets where they are. In other words, Sᵤ is a part of the state that no agent can affect, for example, the location of the targets. Sᵤ may be of 12 possible options which involve combinations of the locations of the two targets. Their presence could be designated as the T1L1 (i.e., target 1 of location 1), T2L2; T1L3, T2L2; T1L5, T2L2; T1L1, T2L4; T1L3, T2L4; and T1L5, T2L4; and the absence of the targets at these locations in that they are outside of the tracking area. In another way, one may look at the options of target 1 as having three possible locations 1, 3 and 5 of presence, plus an absence, for four locations. Target 2 may have two possible locations of 2 and 4 of presence, plus an absence, for three locations. A product of the numbers of these locations, 4 and 3, is 12 for the possible options for Sᵤ.

The term “b”is the initial belief state which may be a probability distribution over S; b=b₁, . . . , bₙ, bᵤ for the corresponding components of S, respectively. The term “A” represents and contains sets of actions for the agents. A=Aᵢ× . . . ×Aₙ, where Aᵢ is a set of actions for agent i. Such actions of a respective agent may include “turn on”, “scan east,” “scan west,” “scan north,” “scan south,” and “turn off”.

Turning on and turning off a sensor may be part of an execution phase. While “on”, the sensor may switch sectors of scanning. This activity may be included in a second phase which may be regarded as an execution phase of plans. The planning may be the first phase. The agents may communicate during planning but not during execution. There is no sensor scanning before deployment or execution of plans.

The term “P” represents a transfer function from one state to another state. There is transition independence in that an agent's local state cannot be affected by other agents. One may note:
Pᵢ:Sᵢ×Sᵤ×Aᵢ×Sᵢ→[0,1], and
Pᵤ: Sᵤ×Sᵤ→[0, 1].

The term “Ω” may indicate observations. Two actual observations may include the presence of the target or the absence of the target. One may note:
Ω=Ω₁× . . . ×Ωₙ.
where Ωᵢ is a set of observations for agent i, for example, a target present in a selected sector of the sensor of agent i. “n” indicates the number of agents, which may be five in the present illustrative instance.

The term “O” may indicate a probability of receiving an observation. There is observation independence in that an agent i's observations are not dependent on observations of other agents. One may note:
Oᵢ:Sᵢ×Sᵤ×Aᵢ×Ωᵢ→[0,1].

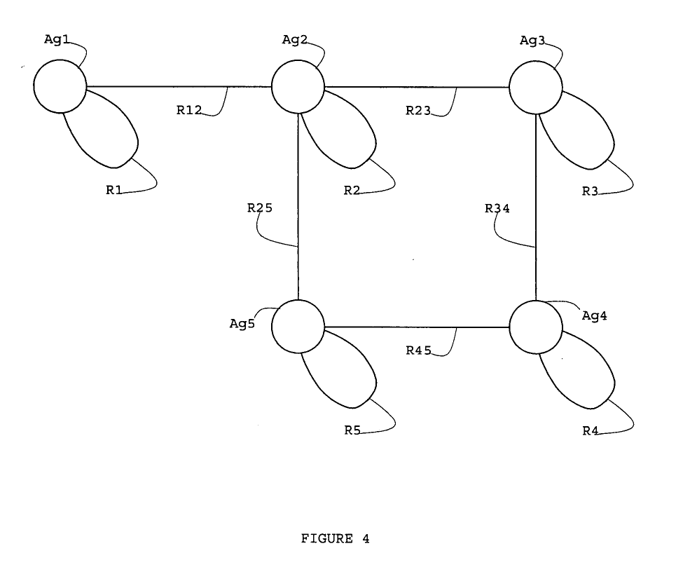

The term “R” indicates a reward function which is decomposable. R may be expressed as a sum dependent on a subset of total agents. R may be equal to costs and reward functions. The costs of the agents are indicated in the graph of FIG. 4 by R1, R2, R3, R4 and R5 and pertain to agents 1, 2, 3, 4 and 5, which may be designated in that figure as Ag1, Ag2, Ag3, Ag4 and Ag5, respectively. The agent costs are indicated by looped edges. The rewards are between two agents such as in a target tracking or sensing by two agents, which are indicated by edges or lines between two agents in FIG. 4. The rewards may be designated by R12+R23+R25+R34+R45, which represent the respective pairs of agents. For instance, R25 indicates the award between agent 2 and agent 5.

The reward function may be expressed as
R(s,a)=Σ₁R₁(s₁ₗ, . . . s₁ₖ, sᵤ, a₁ₗ, . . . a₁ₖ),
where
1⊂Ag, and k=|1|.
A goal is to find a joint policy
π=<π₁, . . . , πₙ>,
where πᵢ is the local policy of agent i such that π maximizes the expected joint reward over a finite horizon T.

Inter-agent interactions may be captured by an interaction hypergraph (Ag, E) which may have more than two nodes per edge and capture the reward function. A regular graph is a special case of a hypergraph. In a hypergraph, there is no restriction on the number of nodes in an edge, while in a regular graph each edge may contain no more than two nodes. Each agent may be a node. A set of hyperedges may be denoted by
E={1|1⊂Ag and R₁ is a component of R}.
Ag is a set of all agents. “1” is a subset (of size 1 or 2 in the sensor example domain) of Ag. “1” is an edge.

In FIG. 4, R1 is an edge of one node and represents the cost of keeping the sensor on. In other words, it is the agent 1's cost for scanning. R12 is a reward edge between agent 1 and agent 2. It is a reward between two agents for target tracking or sensing by two agents, i.e., agent 1 and agent 2. One may note that, for example, agent 2 is present in four edges, three reward edges R12, R23 and R25, and one cost edge R2. A neighborhood of agent 2 is agent 1, agent 3 and agent 5. One may generalize and note the neighborhood of an agent i. The set of agent i's neighbors may be represented as:
Nᵢ={jεAg/j≠i, 1εE, iε1 and jε1}
where j is a particular agent but not the same agent as agent i, i.e., j≠i, E is a set of edges and 1 is one particular edge.

Agents are solving a DCOP where a constraint graph is the interaction hypergraph, the variable (x1, x2, x3, . . . ) at each node is the local policy or plan of that agent of the node, and the expected joint reward is being optimized. The latter reward is the total expected reward for all of the agents together. One would be searching for the plan that optimizes the expected joint reward. It would be the plan that corresponds to the highest hill or peak. There could be more than one plan with the same value.

There are several ND-POMDP theorems which may be noted. The first theorem states that for an ND-POMDP, an expected reward for policy π is the sum of expected rewards for each of the links for policy π. The global value (expected reward) function is decomposable into value (expected reward) functions (V's) for each link. The value or utility V may be broken down to V1, V2, . . . , like the R's, and vice versa. For instance, if there is an R12 then there will be a V12. The local neighbor utility may be noted as V_{π}[Nᵢ] for an expected reward obtained from all links involving agent i for executing policy π. For the local neighborhood of agent 2 for policy π, one may have V_{2,π}=V2+V23+V25+V12. A sum of all of the local utilities may be V=V1+V2+ . . . +V12+ . . . +V45.

One may look at a second theorem which deals with a locality of interaction. It states that for policies π and π′, if πᵢ=π′ᵢ and π_{Ni}=π′_{Ni}, then V₉₀ [Nᵢ]=V_{90′}[Nᵢ]. πand π′ are joint policies and πᵢ and π′ᵢ are similar such that the same is being done in both policies. Relative to π_{Ni}=π′_{Ni}, all Nᵢ are neighbors of agent i, with that being the same then the local neighborhood utility for agent i is the same for both π and π′. In the present example of agents, agent 4 is not a neighbor of agent 2. π₂=π′₂ for agent 2, and π₁=π′₁, π₃=π′₃ and π₅=π′₅, but π₄ is not necessarily equal to π′₄.

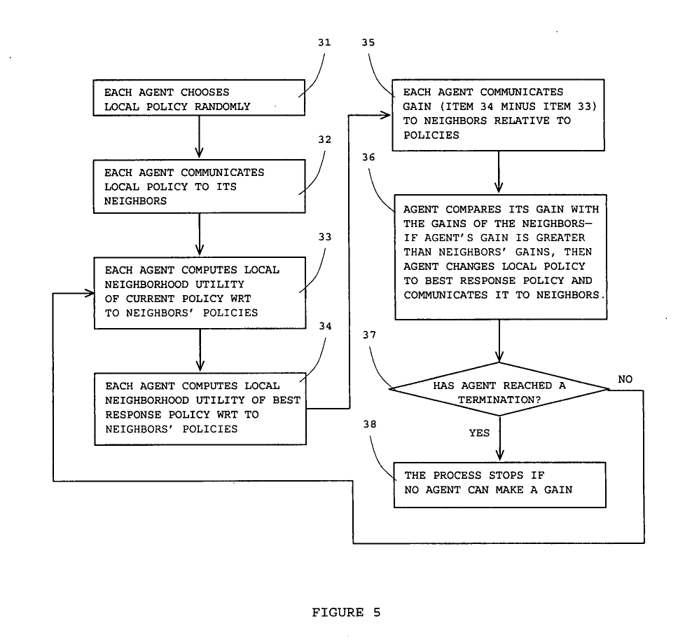

The LID-JESP algorithm (based on the distributed breakout algorithm) and its application may be mentioned. Each agent is to choose individually. This algorithm may be relative to a particular agent. The other agents may be doing the same thing. The algorithm may be effected by a series of steps, actions or items as shown in FIG. 5.

1) Each agent chooses a local policy randomly (item 31);

2) Each agent communicates the local policy to its neighbors (item 32);

3) Each agent computes the neighborhood utility of the current policy with respect (wrt) to the neighbor's policies (item 33). E.g., for agent 4, the local neighborhood utility may be equal to V4+V34+V45.;

4) Each agent computes the local neighborhood expected reward, value or utility of the best response policy wrt the neighbors (item 34). (It determines the best response to the neighbors' policies—this step or item may be a highlight of the present system or approach);

5) Each agent communicates the gain (step 4 minus step 3; item 34 minus item 33) to the neighbors relative to the policies (item 35). (The gain is the difference in value between the best response policy and the previous best response policy after an iteration, the first policy was selected randomly.) One may send the gain to a neighbor; if the policy stays the same then there is no gain to send. The gain may be about any positive number.

6) The agent may compare its gain with what the neighbors claim to make. So if the agent's gain is greater than the gain of the neighbors, then the agent changes the local policy to the best response policy and communicates the changed policy to the neighbors. (Item 36)

7) If the agent goes back to step 3 (item 33) a specified number of times with no agent making a gain, then there may be a termination. (Item 37)

8) The process stops if there is a termination. (Item 38) (If the agents reach a local peak, then no agent can improve the joint policy acting alone, i.e., the local optimum has been reached.)

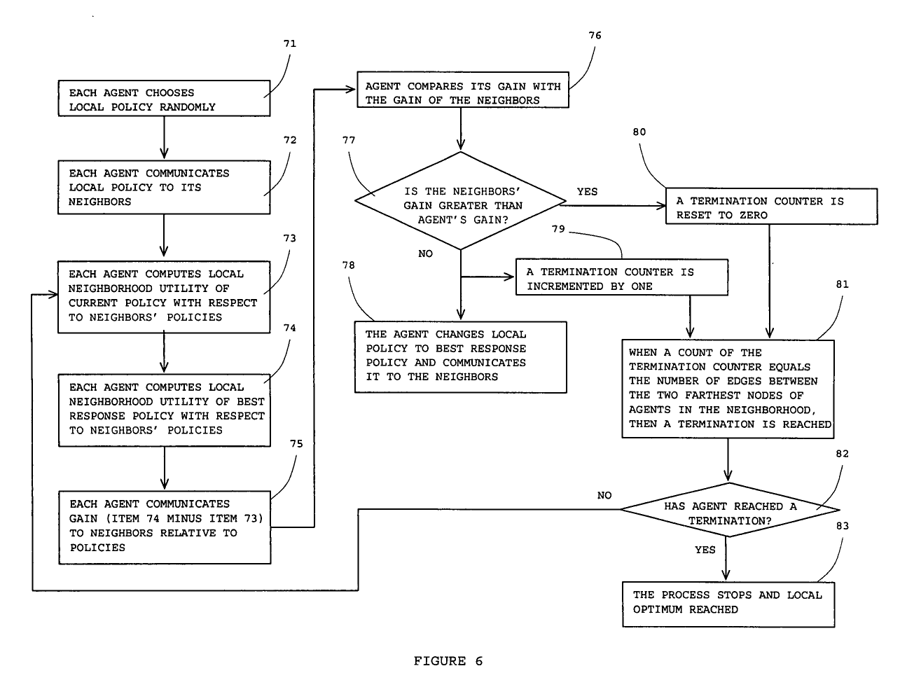

FIG. 6 shows an approach for achieving a local optimum. Each agent may choose a local policy randomly in item 71 then may communicate the local policy to its neighbors in item 72. In item 73, each agent may compute a local neighborhood utility of current policy with respect to the neighbors' policies, and then compute the local neighborhood policy of the best response policy with respect to the neighbors' policies in item 74. Each agent may communicate a gain in item 75, which is item 74 minus item 73, to the neighbors relative to the policies. Then the agent may compare its gain with the gain of the neighbors in item 76. Then the question in item 77 is whether the neighbors' gain is greater than the agent's gain. If not, then the agent may change the local policy to the best response policy and communicate it to the neighbors as indicated in item 78. Further, with a negative answer to item 77, a termination counter may be incremented by one, and this incrementing may be passed on to item 81. With instead a positive answer, the termination counter may be reset to zero, and this resetting may be also be passed on to Item 81. Item 81 indicates the when a count of the termination counter equals the number of edges between the two farthest nodes of the agents in the neighborhood, then a termination is reached. The question of whether the agent has reached a termination may be answered by the count equaling the number of edges. If yes, then the process stops and the local optimum may be regarded as being reached. If no, then the process continues by returning to item 73 and processing on through the items until item 82 is reached for again determining whether a termination has been reached.

Another ND-POMDP (third) theorem which may be noted as relating to the LID-JESP algorithm is that global utility strictly increases with each iteration until a local optimum is reached. This may be regarded as a correctness theorem which indicates that, with each iteration, there is an increase until the agents reaches a peak 15 (local), as shown in FIG. 2.

Termination detection may be effected by an agent maintaining a termination counter relative to steps 7 and 8 above. The counter may be reset to zero if the gain of step 4 minus the gain of step 3 is greater than zero. If not, then the counter is incremented by one. The agent may exchange its counter with the neighbors. The agent may set the counter to the minimum of its own counter and the neighbor's counters. A termination of the LID-JESP process or algorithm may be detected if the counter equals “d” (i.e., a diameter of a graph). The diameter is a distance between the two farthest nodes in FIG. 4 which are nodes 1 and 4. Counting the edges from node, agent or sensor 1 to 4, results in 3 edges. A fourth theorem states that the LID-JESP will terminate within d cycles of searching the local optimum. As noted in the present case, d is 3. That means the iteration or cycle is repeated three times even if nothing is gained. This is the price of using a distributed algorithm where agents can communicate only with their direct neighbors. A fifth theorem states that if the LID-JESP terminates, then the agents are in a local optimum. From the third through fifth theorems, LID-JESP will terminate in a local optimum within d cycles. This means that it is regarded as reaching a local optimum.

Computing the best response policy relative to the neighbors relates to step 4 of LID-JESP algorithm above with some of the mathematical details related here. Given neighbors' fixed policies, each agent is faced with solving a single agent POMDP. A state may be
e^{t}ᵢ=<s^{t}ᵤ, s^{t}ᵢ, s^{t}_{N}_{ᵢ}, \vec{ω}^{t}_{N}_{ᵢ}>.
Note that the state is not fully observable. The transition function may be
P^{t}(e^{t}ᵢ,a^{t}ᵢ, e^{t+1}ᵢ)=Pᵤ(s^{t}ᵤ, s^{t+1}ᵤ)·Pᵢ(s^{t}ᵢ, s^{t}ᵤ, a^{t}ᵢ, s^{t+1}ᵢ)·P_{N}_{ᵢ}(s^{t}_{N}_{ᵢ}, s^{t}ᵤ, a^{t}_{N}_{ᵢ}, s^{t+1}_{N}_{ᵢ})·O_{N}_{ᵢ}(s^{t+1}_{N}_{ᵢ}, s^{t+1}ᵤ, a^{t}_{N}_{ᵢ}, ω^{t+1}_{N}_{ᵢ}).
The observation function may be
O^{t}(e^{t+1}ᵢ, a^{t}ᵢ, Ω^{t+1}ᵢ)=Oᵢ(s^{t+1}ᵢ, s^{t+1}ᵤ, a^{t}ᵢ, ω^{t+1}ᵢ).
The reward function may be

$${\sum }_{l ∈ E s . t . i ∈ l} {R}_{l} ( {s}_{l 1} , … , {s}_{lk} , {s}_{u} , 〈 {a}_{l 1} , … , {a}_{lk} 〉 ) .$$

The best response may be computed using a Bellman backup approach as noted in the related art.

Another stage is to implement a global optimal algorithm (GOA). This algorithm is similar to variable elimination and relies on a tree structured interaction graph. The interaction graph does not have cycles and the graph is not a hypergraph. A cycle cutset algorithm may be used to eliminate cycles.

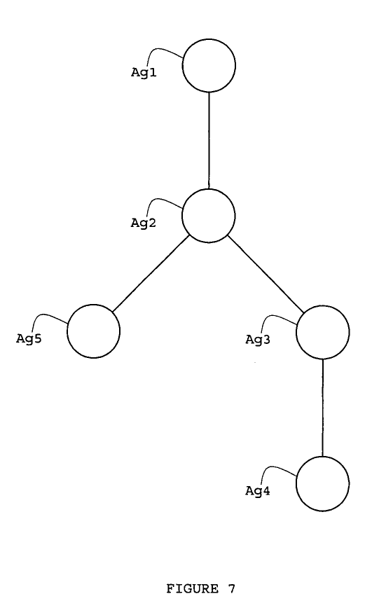

The algorithm may assume just binary interactions. That is, the edges have two or less agents as can be noted in FIG. 7, which is a redrawn version of FIG. 4. In FIG. 7, agents or nodes 1, 2, 3, 4 and 5 may be labeled as Ag1, Ag2, Ag3, Ag4 and Ag5, respectively. In this Figure, agent 1 or node 1 has no parent and thus is a root. Nodes 4 and 5 have no children and thus are leaves. There are two phases of the algorithm, upward propagation from the leaves to the root and downward propagation from the root to the leaves. One may compute up for values and compute down for policies. A policy is an actual plan and V (i.e., value) is a value (expected reward) of the plan. (It assumes binary interactions.) For instance, an agent 2 would have values V25, V32 and V34 of the children. An optimal response may then be computed from agent 2 to agent 1, which includes the best value of everything below it including itself. Agent 1 has one child and no parent. Each agent or node has a value function.

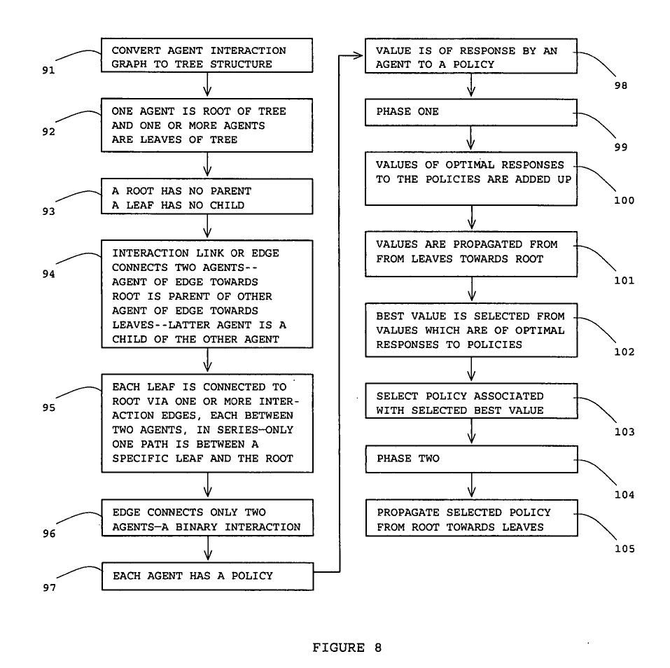

FIG. 8 is an illustrative example of the GOA. One may start with converting an interaction graph like that of FIG. 4 into a tree structure like that of FIG. 7, as indicated by item 91. Item 92 indicates that just one agent is a root of the tree with one or more agents as leaves of the tree. A root has no parent and a leaf has no child as noted by item 93. In the tree an interaction link or edge connects two agents. The agent at one end of the edge towards the root (whether the agent is the root or not) is the parent of the agent at the other end of the edge towards the leaf (whether the agent is the leaf or not). The agent near or as the leaf is the child of the agent of the edge near or as the root, as indicated by item 94. Each leaf may be connected to the root via one or more interaction edges. Each edge connects two agents. The edges with the agents may be connected in series in that only one path runs between a specific leaf and the root, as informed by item 95 in FIG. 8 and the tree in FIG. 7. Item 96 indicates that an edge connects only two agents—a binary interaction—in the illustrative example. Each agent has a policy and a value is of a response by an agent to a policy as noted by items 97 and 98, respectively.

Phase 1 of GOA is where the values are propagated upwards from the leaves to the root as noted by items 99 and 100, respectively, in FIG. 8. Each agent, such as agent 3 (Ag3 in FIG. 7), for each policy, may sum up the values of its children's optimal responses. The agent 3, computes the value, which it gets from agent 4, and is of the optimal response to each of the parent's policies. These values are communicated to the parent. For instance, agent 4 sends it to agent 3 and agent 5 sends it to agent 2. For each one of the parents' policies, the child may compute a value of its optimal response. The optimal value may be regarded as the optimal response to the policy. The optimal value V34 may be by the child Ag4 for the policy of the parent Ag3. The optimal value V23 may be by the child Ag3 for the policy of the parent Ag2. The optimal value V25 may be by the child Ag5 for the policy of the parent Ag2. The optimal value V12 may be by the child Ag2 for the policy of the parent Ag1.

The values of the optimal responses (e.g., V34, V23, V25 and V12) to the policies may be added up as the values are propagated from the leaves towards the root, as indicated by items 99 and 100 of FIG. 8. The best value may be selected from the values which are of optimal responses to the policies as indicated in item 102. In item 103, the policy associated with the selected best value may be selected. Phase two at items 104 and 105 is where the selected policy may be propagated from the root towards the leaves.

Phase 2 of GOA is where the policies are propagated downwards from the root to leaves. An agent may choose a policy corresponding to an optimal response to a parent's policy. Then the agent may communicate its policy to its children. The agent 1 considers only itself since it has no parent. The value is V1 plus all of the values below. Agent 1 communicates its policy to agent 2. It may be looked up in a table of values propagated upwards. There may be several actions here.

More specifics of the GOA may be mentioned. As to the global optimal, one may consider only binary constraints but the approach can be applied to n-ary constraints. A distributed cutset algorithm may be run in case the graph is not a tree. An illustrative example of an algorithm for a phase 1 of the global optimal is as follows:

1) Convert graph into trees and a cycle cutset C

2) For each possible joint policy nc of agents in C
1) Val[π_{C}]=0
2) For each tree of agents
   1) Val[π_{C}]=+DP−Global (tree, π_{C})

3) Choose joint policy with highest value.

A GOA may be similar to variable elimination. It may rely on a tree structured interaction graph. A cycle cutset algorithm may utilize to eliminate cycles. For the GOA, just binary interactions may be assumed. Phase 1 involves values which are propagated upwards from leaves to a root. From the deepest nodes in the tree to the root, one may do the following:

1) For each of agent i's policies πᵢ, do
eval(πᵢ)←Σ_{ci} value^{πi}_{ci} where value^{πi}_{ci} is received from child ci

2) For each parent's policy πⱼ do
value^{πj}ᵢ←0 for each of agent i's policy πᵢ, do set current-eval←expected-reward(πⱼ, πᵢ)+eval (πᵢ)
if value^{πj}ᵢ←current-eval then value^{πj}ᵢ←current-eval

send value^{πj}ᵢ to parent j.

As indicated herein, phase 2 is when the policies (i.e., plans) are propagated downwards from the root to the leaves.

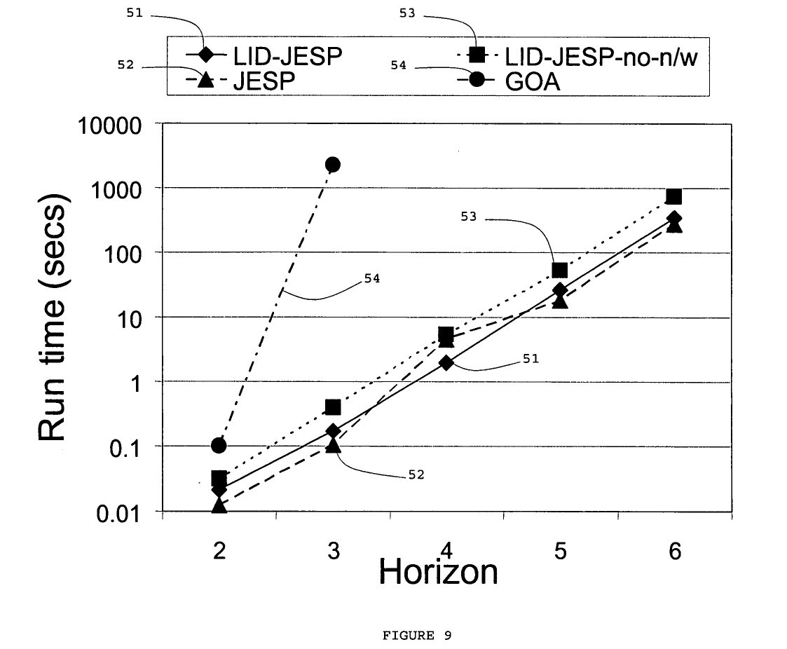

Various graphs of experiments show the speed of the present system. LID-JESP-no-n/w (network) ignores the interaction graph. The no network (n/w) designation means that the algorithm ignores that locality (exists). One may note from a graph in FIG. 9 of run time in seconds versus horizon for a 3 agent chain that the GOA 54 appears very slow, or that the present LID-JESP 51 appears exponentially faster than the GOA. Also, the LID-JESP appears to fair better than JESP 52 and LID-JESP-no-n/w 53.

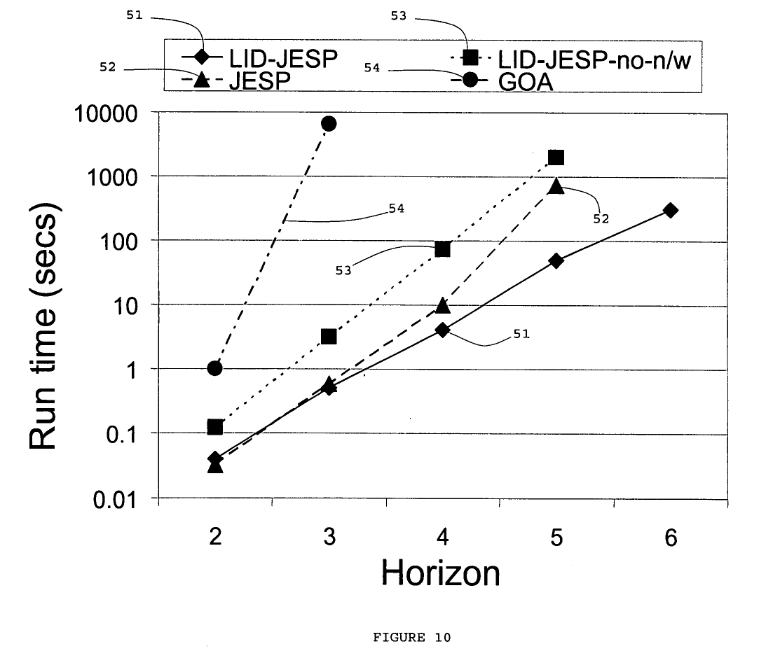

As to the 4 agent chain in the graph of run time versus horizon in FIG. 10, the LID-JESP 51 appears faster than the JESP 52 and LID-JESP-no-n/w 53. The JESP appears to be published in a Ph.D. dissertation entitled “Coordinating Multiagent Teams in Uncertain Domains Using Distributed POMDPS,” dated December 2004, by Ranjit Nair. Also, the LID-JESP 51 appears exponentially faster than the GOA 54 for the 4 agent chain.

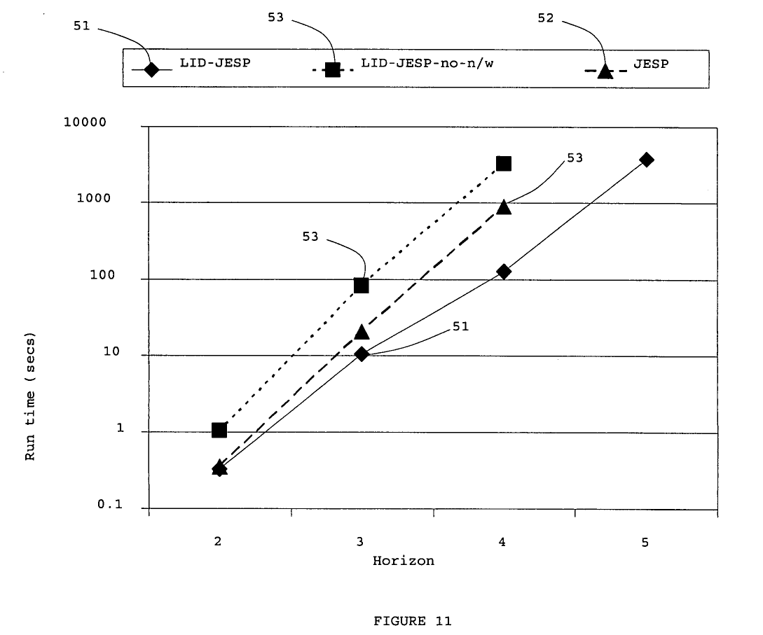

As to the 5 agent chain, a graph of run time versus horizon in FIG. 11 shows the LID-JESP 51 to appear much faster than JESP 52 and the LID-JESP-no-n/w 53.

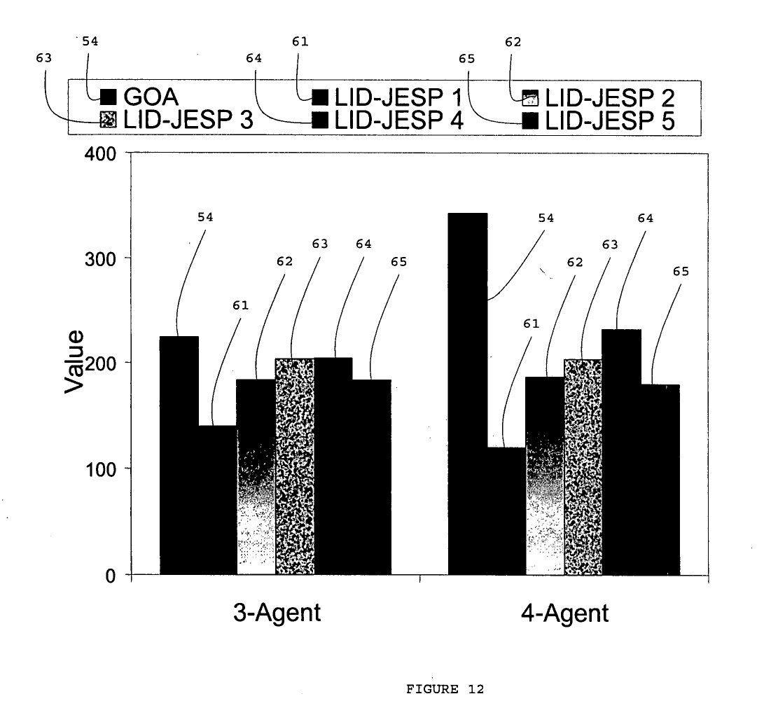

FIG. 12 reveals a graph that shows a comparison of values of GOA 54 and LID-JESP 51 for one and more runs for the three agent and four agent configurations, respectively. The LID-JESP 51 is graphed for one run 61, two runs 62, three runs 63, four runs 64 and five runs 65. The LID-JESP values appear comparable to the GOA values. Random restarts may be used to find the global optimal. For the 3 agent chain on the left side of the graph, the GOA has the highest peak value, which is a global peak. The other peak values are local and different for the various series of runs of LID-JESP. For the 4 agent chain at the right side of the graph, the GOA has the highest peak value and the different series of runs of the LID-JESP have different local peak values. One reason for the various peaks of local values may be due to the different random starting points for the algorithm.

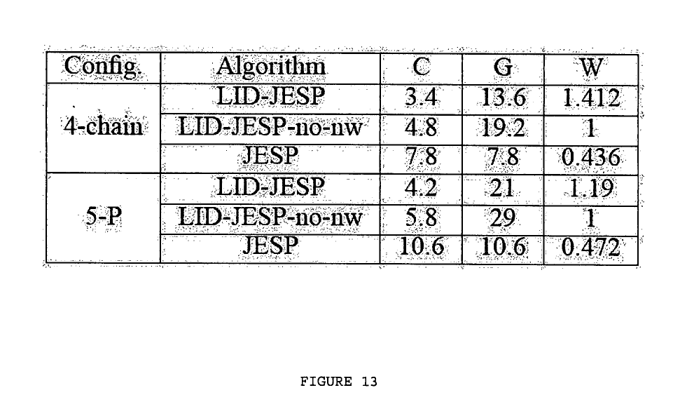

FIG. 13 shows a table that shows a comparison of the different algorithms for a 4 chain configuration and a 5 chain configuration in terms of the number of cycles (C), the number of times best response is computed per cycle, i.e., times of step 4, (G), and the number of agents that change (update) their policies in a cycle (W). One may note from the table that the LID-JESP converges in fewer cycles (column C) and allows multiple agents to change their policies in a single cycle (column W). It may be further noted that the JESP has fewer get value calls (column G) than LID-JESP; however, such calls are slower. Overall, the LID-JESP outperforms the other algorithms listed in the table for both configurations, particularly in speed.

LID-JESP has less complexity than other algorithms, such as JESP and GOA. As to the complexity of best response, JESP depends on the entire world state and on the observation histories of all agents, as underlined in
JESP: O(|S|²×(|Ai|×πⱼ|Ωⱼ|)^{T}).
LID-JESP depends on observation histories of only neighbors and depends only on Sᵤ, Sᵢ and S_{Ni}, as indicated by the underlined portions of
LID-JESP: O(|Sᵤ×Sᵢ×S_{Ni}|²×(|Aᵢ|×π_{jεNi}|Ωⱼ|)^{T}).
Increasing the number of agents does not affect complexity if there is a fixed number of neighbors as in LID-JESP. Related-art algorithms may increase in complexity with an increase of the number of agents, which can become unwieldy to function.

GOA may have some complexity savings over a brute force global optimal approach as indicated by the underlined portions of
Brute force: O(πⱼ|πⱼ|×|S|²×πⱼ|Ωⱼ|^{T}).
where πⱼ is a product; and
GOA: O(n×|πⱼ|×|Sᵤ×Sᵢ×Sⱼ|²×|Aᵢ|^{T}×|Ωᵢ|^{T}×|Ωⱼ|^{T}).
An increasing number of agents keeping the number of neighbors constant will cause a linear increase of run time.

In conclusion, DCOP algorithms are applied to finding a solution to the distributed POMDP. Exploiting the “locality of interaction” reduces run time. The LID-JESP may be based on DBA. The agents converge to a locally optimal joint policy. The GOA may be based on variable elimination.

Thus, one may have here parallel algorithms for distributed POMDPs. Exploiting the “locality of interaction” reduces run time, as noted above. Complexity increases linearly with an increased number of agents; however, here is a fixed number of neighbors for any agent despite an increased number of agents.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A local optimum seeking system comprising:
a plurality of agents; and
wherein:
a) each agent of the plurality of agents has one or more neighbors;
b) the neighbors are agents of the plurality of agents;
c) each agent chooses a local policy;
d) each agent communicates the local policy to its neighbors, wherein the neighbors have policies;
e) each agent determines a utility of its local policy relative to the neighbors' policies, and the utility of the best response local policy relative to the neighbors' policies;
f) if the utility of the best response local policy is greater than the utility of the local policy by an amount of gain, then the agent communicates the amount of gain to the neighbors; and
g) if the utility of the best response local policy is not greater than the utility of the local policy, then the agent changes the local policy to the best response local policy and communicates a changed best response policy to the neighbors, and an iteration of items e) through g) of this claim may be repeated.

2. The system of claim 1, where a neighborhood of an agent is limited to agents having a direct interaction with the agent.

3. The system of claim 2, wherein each agent reaches a termination if no agent makes a gain between the value of the local policy or previous best policy, and the best response policy.

4. The system claim 3, wherein if a termination is reached, then a local optimum is achieved.

5. A local optimum seeking system comprising:
a plurality of agents; and
wherein:
1) each agent chooses a local policy;
2) each agent communicates the local policy to its neighbors having a direct interaction to the agent;
3) each agent determines a local neighborhood utility of a current policy with respect to the neighbor's policies;
4) for each agent, the local neighborhood utility is sum of expected values of the agent, and of each direct interaction between each neighbor and the agent;
5) each neighbor is an agent of the plurality of agents; and
6) each agent determines the local neighborhood expected reward, value or utility of the best response policy with respect to the neighbors' policies.

6. The system of claim 5, further comprising:
7) each agent determines the best response to the neighbors' policies;
8) each agent communicates a gain (item 6 minus item 3 of claim 1) to the neighbors relative to the policies;
9) the gain is the difference in value between the best response policy and the previous best response policy, after an iteration of item 1 through item 8, or the local policy;
10) each agent sends the gain to a neighbor, but if the policy stays the same then there is no gain to send;
11) each agent compares its gain with gains that the neighbors claim to make; and
12) if the agent's gain is greater than the gains of the neighbors, then the agent changes the local policy to the best response policy and communicates the changed policy to the neighbors.

7. The system of claim 6, further comprising 13) if the agent goes back to step 3 a specified number of times with no agent making a gain, then there may be a termination.

8. The system of claim 7, further comprising 14) the process stops if there is a termination.

9. The system of claim 6, wherein the agents together reach a local peak and/or no agent can improve a joint policy acting alone, a local optimum has been reached.

10. The system of claim 6, wherein if any of the neighbors' gains is not greater than agent's gains, then the agent changes the local policy to the best response policy and communicates it to the neighbors.

11. The system of claim 8, wherein a termination counter is incremented by one.

12. The system of claim 11, when a count of the termination counter equals a number of direct interactions between the two farthest nodes of agents in the neighborhood of the agent, then a termination is reached.

13. The system of claim 7, if a termination is reached, then a local optimum is reached.

14. A method for seeking a global optimum comprising:
providing agents organized in a tree-like structure; and
wherein:
one agent is a root of the tree-like structure;
one or more agents are leaves of the tree-like structure;
each leaf is connected to the root via one or more interaction links;
at least two or more links are connected in a series with an agent at a node of each connection between each pair of connected links;
the root has no parent;
each leaf has no child;
a link connects only two agents;
an agent, relative to another agent connected by a same link, is a child to the other agent in a direction towards the root, and the other agent is a parent to the agent in a direction towards a leaf; and
there is only one path from a leaf to the root.

15. The method of claim 14, wherein:
each agent has a policy; and
a value is of an optimal response of an agent to its parent's policy.

16. The method of claim 15, further comprising:
propagating values from the agents to the root;
selecting a best value at the root; and
wherein the best value corresponds to an optimal response to a policy.

17. The method of claim 16, further comprising:
selecting the policy from which an optimal response to the policy had a value that was selected as the best value; and
determining a selected policy that evoked an optimal response which has a best value at the root.

18. The method of claim 17, further comprising propagating the selected policy from the root to the leaves.

19. The method of claim 18, wherein the values from the children's optimal responses for each policy are communicated to the respective parents.

20. The system of claim 19, wherein:
the agent that is the root chooses a policy corresponding to an optimal response to a policy of the parent; and
the policy is communicated via the one or more series connections to the child.

21. A global optimum seeking system comprising:
at least two agents; and
at least one edge; and
wherein:
one agent is a root;
at least one agent is a leaf;
at least one agent is a parent;
at least one agent is a child;
the root has no parent;
a leaf has no child;
each parent has a child;
each child has a parent;
each parent has a policy;
a value is of an optimal response by a child to the policy of the parent of the child;
a value is propagated from the leaf to the root;
a policy is propagated from the root to the leaves; and
the policy corresponds to the value of the optimal response by the respective child.

22. The system of claim 21, wherein:
the value is propagated from the leaf to the root via at least one edge; and
the policy is propagated from the root to the leaf via at least one edge.

23. The system of claim 22, wherein:
at least one agent is situated between the root and a leaf; and
each edge provides an interaction link between two agents.

24. The system of claim 23, wherein:
each edge is an interaction link between only two agents; and
an agent of an interaction link, closer to the root than another agent of the interaction link, is a parent of the other agent, and the other agent is a child of the parent.

25. The system of claim 24, wherein:
a plurality of edges as a plurality of links between agents compose one or more series connections without a closed loop; and
each of the one or more series connections with each leaf has one path to the root.

26. The system of claim 25, wherein:
each agent has an optimal response to a policy of a parent;
each optimal response has a value; and
each value is propagated towards the root via the one or more series connections.

27. A method for exploiting a locality of interaction in uncertain domains, comprising:
choose local policy randomly;
communicate the local policy to neighbors;
compute local neighborhood utility of current policy with respect to neighbors' policies;
compute local neighborhood utility (value) of best response policy with respect to the neighbors;
communicate a gain of neighborhood utility of the best response policy over neighborhood utility of current policy;
if the gain is greater than a gain of the previous best response policy, then change local policy to the best response policy and communicate changed policy to the neighbors;
if the gain is not greater than the gain of the previous response policy, then repeat the steps from compute the local neighborhood utility of current policy with respect to the neighbors' policy until the gain is greater than the gain of the previous response policy.
